(19) United States
(12) Patent Application Publication
(10) Pub. No.: US 2025/0308805 A1
(43) Pub. Date: Oct. 2, 2025

(54) ELECTROLYTIC CAPACITOR

(71) Applicant: Panasonic Intellectual Property Management Co., Ltd., Osaka (JP)

(72) Inventors: Hiroyuki NAKAKI, YAMAGUCHI KEN (JP); Kazuyo SAITO, OSAKA FU (JP); Koji MATSUTORI, YAMAGUCHI KEN (JP)

(21) Appl. No.: 19/092,503

(22) Filed: Mar. 27, 2025

(30) Foreign Application Priority Data
Mar. 28, 2024 (JP) 2024-054245

(51) Int. Cl. H01G 9/02; H01G 9/048

(52) U.S. Cl. CPC H01G 9/02; H01G 9/048

(57) ABSTRACT

An electrolytic capacitor includes a capacitor element and a liquid component. The capacitor element includes an anode foil, a cathode foil, a separator disposed, and first and second conductive polymer layers, the anode foil, the cathode foil, and the separator are wound in a longitudinal direction of the elongated shapes to form a wound body, the anode foil includes a porous portion in which a portion of a surface is covered with a dielectric layer, the cathode foil is arranged opposite the dielectric layer, the separator contains a fiber material, the first conductive polymer layer covers a portion of a surface of the dielectric layer in the porous portion, the second conductive polymer layer covers a portion of a surface of the fiber material in the separator, the first conductive polymer layer and the second conductive polymer layer contain a first conductive polymer and a second conductive polymer, respectively.

### CROSS REFERENCE TO RELATED APPLICATION

The present application is based on and claims priority under 35 U.S.C. § 119 with respect to the Japanese Patent Application No. 2024-054245 filed on Mar. 28, 2024, of which entire content is incorporated herein by reference into the present application.

### TECHNICAL FIELD

The present invention relates to an electrolytic capacitor.

### BACKGROUND

An electrolytic capacitor includes, for example, a capacitor element and an electrolyte, and the capacitor element usually includes an anode foil with a dielectric layer, a cathode foil arranged opposite the dielectric layer, and a separator between the anode foil and the cathode foil. Such electrolytic capacitors include known electrolytic capacitors that include, as electrolytes, a liquid component (e.g., an electrolyte solution) filling voids in the capacitor element and a conductive polymer between the anode foil and the cathode foil. That is, electrolytic capacitors including a solid electrolyte and a liquid electrolyte are known.

JP 2022-117355A describes an electrolytic capacitor including a capacitor element that includes an anode foil with a dielectric layer on its surface, a cathode foil, a separator between the anode foil and the cathode foil, a hydroxyl group-containing compound, and a conductive polymer. JP 2022-117355A describes the use of a separator containing synthetic fiber and cellulose fiber as the separator, and the use of at least one compound (excluding polymers) selected from the group consisting of sugars and polyvalent alcohols as the hydroxyl group-containing compound in the electrolytic capacitor. In the electrolytic capacitor described in JP 2022-117355A, the conductive polymer and the hydroxyl group-containing compound adhere to a surface layer and the inside of the separator, and the hydroxyl group-containing compound is unevenly distributed in the separator. According to JP 2022-117355A, the electrolytic capacitor configured as described above can have a high capacitance and reduce ESR (equivalent series resistance). That is, JP 2022-117355A describes an electrolytic capacitor that can have a high capacitance while suppressing an increase in the ESR.

WO 2017/017947 describes an electrolytic capacitor including an anode body with a dielectric layer, a solid electrolyte layer in contact with the dielectric layer of the anode body, and an electrolyte solution, wherein the electrolyte solution contains a solvent and a solute. WO 2017/017947 describes the use of a solvent including a glycol compound as the solvent, and the use of a solute including a carboxylic acid component in an amount of 200 parts by mass or more with respect to 100 parts by mass of a base component as the solute in the electrolytic capacitor. According to WO 2017/017947, the electrolytic capacitor configured as described above has excellent withstand voltage and heat resistance and can maintain a low ESR. That is, WO 2017/017947 describes an electrolytic capacitor that can achieve excellent withstand voltage and heat resistance while suppressing an increase in the ESR.

WO 2020/158780 describes an electrolytic capacitor that includes a capacitor element including an electrode foil and a conductive polymer layer formed on the electrode foil. In the electrolytic capacitor described in WO 2020/158780, the conductive polymer layer covers 90% or more of the area of a main surface of the electrode foil, and the conductive polymer layer includes a first conductive polymer layer containing a first conductive polymer component and a second conductive polymer layer covering a portion of the first conductive polymer layer and containing a second conductive polymer component. According to WO 2020/158780, the electrolytic capacitor configured as described above can reduce the ESR. That is, WO 2020/158780 describes an electrolytic capacitor that can suppress an increase in the ESR.

### SUMMARY

In recent years, there are increasing demands for suppressing both an increase of a leakage current and an increase in the ESR in an electrolytic capacitor that includes a liquid component and a conductive polymer layer as electrolytes.

However, in any known documents such as JP 2022-117355A, WO 2017/017947, and WO 2020/158780, sufficient studies have not yet been made to suppress both an increase of a leakage current and an increase in the ESR in am electrolytic capacitor including a liquid component and a conductive polymer layer as electrolytes.

Therefore, the present disclosure provides an electrolytic capacitor that can suppress both an increase of a leakage current and an increase in the ESR.

One aspect of the present invention relates to an electrolytic capacitor including a capacitor element and a liquid component, wherein the capacitor element includes an anode foil having an elongated shape, a cathode foil having an elongated shape, a separator having an elongated shape and disposed between the anode foil and the cathode foil, and a first conductive polymer layer and a second conductive polymer layer between the anode foil and the cathode foil, the anode foil, the cathode foil, and the separator are wound in a longitudinal direction of the elongated shapes to form a wound body, the anode foil includes a porous portion in which at least a portion of a surface is covered with a dielectric layer, the cathode foil is arranged opposite the dielectric layer, the separator contains a fiber material, the first conductive polymer layer covers at least a portion of a surface of the dielectric layer in the porous portion, the second conductive polymer layer covers at least a portion of a surface of the fiber material in the separator, the first conductive polymer layer contains a first conductive polymer, the second conductive polymer layer contains a second conductive polymer, a content of the first conductive polymer in the porous portion is higher than a content of the second conductive polymer in the porous portion, a content of the second conductive polymer in the separator is higher than a content of the first conductive polymer in the separator, and electrical conductivity of the first conductive polymer layer is lower than electrical conductivity of the second conductive polymer layer.

According to the present disclosure, it is possible to provide an electrolytic capacitor that can suppress both an increase of a leakage current and an increase in the ESR.

### BRIEF DESCRIPTION OF THE DRAWINGS

FIG. 1 is a schematic diagram of a capacitor element according to an embodiment of the present disclosure with a portion thereof expanded.

FIG. 2 is an enlarged schematic cross-sectional view showing a main part of the capacitor element according to the embodiment of the present disclosure.

FIG. 3 is a schematic diagram showing the inside of a separator included in the capacitor element according to the embodiment of the present disclosure.

FIG. 4 is a schematic cross-sectional view showing a variation of the capacitor element according to the embodiment of the present disclosure.

FIG. 5 is a schematic cross-sectional view of an electrolytic capacitor according to an embodiment of the present disclosure.

### DETAILED DESCRIPTION

The following describes an embodiment of the present disclosure using examples, but the present disclosure is not limited to the following examples. In the following description, specific numerical values and materials are described as examples, but other numerical values and materials may also be used as long as effects of the present disclosure can be obtained. Known constituent elements may also be applied to constituent elements of characteristic parts of the present disclosure. The wording “a range between a numerical value A and a numerical value B” as used in this specification refers to a range that includes the numerical values A and B.

In the following description, if examples of the lower limit and the upper limit of numerical values relating to a specific physical property or condition are described, any of the examples of the lower limit and the examples of the upper limit may be combined suitably unless the lower limit is greater than or equal to the upper limit. If a plurality of materials are described as examples, any one of the materials may be used alone or two or more of the materials may be used in combination unless otherwise stated.

The present disclosure encompasses combinations of matters described in two or more claims selected suitably from the multiple claims described in the attached claims. In other words, as long as there is no technical inconsistency, it is possible to combine matters described in two or more claims selected suitably from the multiple claims described in the attached claims.

### [Electrolytic Capacitor]

An electrolytic capacitor according to an embodiment of the present disclosure includes a capacitor element and a liquid component. In the electrolytic capacitor according to the embodiment of the present disclosure, the capacitor element includes an anode foil having an elongated shape, a cathode foil having an elongated shape, a separator having an elongated shape and disposed between the anode foil and the cathode foil, and a first conductive polymer layer and a second conductive polymer layer between the anode foil and the cathode foil.

In the electrolytic capacitor according to the embodiment of the present disclosure, the anode foil, the cathode foil, and the separator are wound in the longitudinal direction of the elongated shapes to form a wound body, the anode foil includes a porous portion in which at least a portion of a surface is covered with a dielectric layer, the cathode foil is arranged opposite the dielectric layer, and the separator contains a fiber material.

In the electrolytic capacitor according to the embodiment of the present disclosure, the first conductive polymer layer covers at least a portion of a surface of the dielectric layer in the porous portion, and the second conductive polymer layer covers at least a portion of a surface of the fiber material in the separator. In the electrolytic capacitor according to the embodiment of the present disclosure, the first conductive polymer layer contains a first conductive polymer, the second conductive polymer layer contains a second conductive polymer, the content of the first conductive polymer is higher than the content of the second conductive polymer in the porous portion, and the content of the second conductive polymer is higher than the content of the first conductive polymer in the separator. In the electrolytic capacitor according to the embodiment of the present disclosure, the electrical conductivity of the first conductive polymer layer is lower than that of the second conductive polymer layer.

It is important that, in the electrolytic capacitor according to the embodiment of the present disclosure, the first conductive polymer layer containing the first conductive polymer covers at least a portion of the surface of the dielectric layer in the porous portion, the second conductive polymer layer containing the second conductive polymer covers at least a portion of the surface of the fiber material in the separator, the content of the first conductive polymer is higher than the content of the second conductive polymer in the porous portion, the content of the second conductive polymer is higher than the content of the first conductive polymer in the separator, and the electrical conductivity of the first conductive polymer layer is lower than that of the second conductive polymer layer. This is because of the following reasons.

In the capacitor element of the electrolytic capacitor, the porous portion is formed in at least one main surface of the anode foil and the dielectric layer is formed to cover at least a portion of the porous portion as described above to increase the capacitance. If a solid electrolyte such as a conductive polymer sufficiently covers the dielectric layer inside a plurality of pores included in the porous portion, a sufficient conductive path can be formed between the anode foil and the cathode foil, and accordingly, the ESR of the electrolytic capacitor can be reduced.

On the other hand, if the dielectric layer has a defect such as a crack, a leakage current occurs in the defect. In such a case, if the solid electrolyte such as a conductive polymer near the defect of the dielectric layer has a low electrical conductivity, the leakage current occurring in the defect can be reduced. Therefore, if the solid electrolyte is constituted by a conductive polymer having a low electrical conductivity, the leakage current in the electrolytic capacitor can be reduced. However, if the entire solid electrolyte between the anode foil and the cathode foil is constituted by a conductive polymer having a low electrical conductivity, the electrical conductivity of the conductive path between the anode foil and the cathode foil decreases, and the ESR of the electrolytic capacitor increases.

In the electrolytic capacitor according to the embodiment of the present disclosure, the first conductive polymer layer containing the first conductive polymer covers at least a portion of the surface of the dielectric layer in the porous portion, the second conductive polymer layer containing the second conductive polymer covers at least a portion of the surface of the fiber material in the separator, the content of the first conductive polymer is higher than the content of the second conductive polymer in the porous portion, the content of the second conductive polymer is higher than the content of the first conductive polymer in the separator, and the electrical conductivity of the first conductive polymer layer is lower than that of the second conductive polymer layer. That is, in the electrolytic capacitor according to the embodiment of the present disclosure, the dielectric layer in the porous portion of the anode foil is covered mainly by the first conductive polymer layer, and the surface of the fiber material in the separator is covered by the second conductive polymer layer. Therefore, a leakage current occurring in a defect can be suppressed due to the first conductive polymer layer having a low electrical conductivity being disposed on the surface of the dielectric layer (i.e., near the defect of the dielectric layer), and an increase in the ESR of the electrolytic capacitor can be suppressed due to the second conductive polymer layer having a higher electrical conductivity than the first conductive polymer layer being disposed in the conductive path between the anode foil and the cathode foil.

Moreover, for example, if a polymerization degree of the first conductive polymer contained in the first conductive polymer layer is set lower than a polymerization degree of the second conductive polymer contained in the second conductive polymer layer to make the electrical conductivity of the first conductive polymer layer lower than the electrical conductivity of the second conductive polymer layer, the first conductive polymer contained in the first conductive polymer layer becomes smaller than the second conductive polymer contained in the second conductive polymer layer, and therefore, the first conductive polymer layer can sufficiently permeate the inside of a plurality of pores in the porous portion. On the other hand, the second conductive polymer is large, and therefore, is unlikely to permeate the inside of the pores in the porous portion. Therefore, a sufficient conductive path can be formed by the conductive polymer layers (the first conductive polymer layer and the second conductive polymer layer) between the anode foil and the cathode foil, and the ESR of the electrolytic capacitor can be reduced. On the other hand, an increase of the leakage current can be suppressed because the second conductive polymer layer with a high electrical conductivity is unlikely to be disposed near defects of the dielectric layer inside the pores.

### <Capacitor Element>

As described above, the capacitor element according to the embodiment of the present disclosure includes the anode foil having an elongated shape, the cathode foil having an elongated shape, the separator having an elongated shape and disposed between the anode foil and the cathode foil, and the first conductive polymer layer and the second conductive polymer layer between the anode foil and the cathode foil. In the capacitor element according to the embodiment of the present disclosure, the anode foil, the cathode foil, and the separator are wound in the longitudinal direction of the elongated shapes to form a wound body. The following describes the anode foil, the cathode foil, the separator, the first conductive polymer layer, and the second conductive polymer layer.

### (Anode Foil)

Examples of the anode foil include a metal foil containing at least one valve action metal such as titanium, tantalum, aluminum, and niobium. The anode foil may be a valve action metal foil (e.g., an aluminum foil). The anode foil may contain a valve action metal in the form of an alloy containing the valve action metal or a compound containing the valve action metal. The thickness of the anode foil may be 15 μm or more and 300 μm or less. As described above, the anode foil includes a porous portion in which at least a portion of the surface is covered with a dielectric layer. The porous portion includes a plurality of pores extending from a main surface of the anode foil toward a center portion of the anode foil. The porous portion can be formed by etching the surface of the anode foil, for example. The porous portion may be formed only in one main surface of the anode foil or in both main surfaces of the anode foil. The porous portion is preferably formed in both main surfaces of the anode foil.

As described above, at least a portion of the surface of the porous portion of the anode foil is covered with a dielectric layer. The porous portion has an outer surface that constitutes the main surface of the anode foil and an inner surface that constitutes inner walls of the pores. Therefore, in the anode foil, at least a portion of the outer and inner surfaces of the porous portion is covered with the dielectric layer. The dielectric layer may be formed by performing chemical conversion treatment on the anode foil. In this case, the dielectric layer may contain an oxide of the valve action metal (e.g., aluminum oxide). It is sufficient that the dielectric layer functions as a dielectric, and the dielectric layer may also be formed by a dielectric other than an oxide of a valve action metal.

### (Cathode Foil)

There is no particular limitation on the cathode foil as long as the cathode foil functions as a cathode. Examples of the cathode foil include a metal foil (e.g., an aluminum foil). There is no particular limitation on the type of metal contained in the metal foil. The metal may be a valve action metal or an alloy containing a valve action metal. The thickness of the cathode foil may be 15 μm or more and 300 μm or less. Similarly to the anode foil, the cathode foil may include a porous portion in at least a portion of its surface. The porous portion can be formed by etching the surface of the cathode foil, for example. The porous portion may be formed only in one main surface of the cathode foil or in both main surfaces of the cathode foil. In the cathode foil, the porous portion may have an outer surface that constitutes the main surface of the cathode foil and an inner surface that constitutes inner walls of a plurality of pores.

A dielectric layer may also be formed in at least a portion of the porous portion of the cathode foil. In the cathode foil, at least a portion of the outer and inner surfaces of the porous portion may be covered with the dielectric layer. That is, the cathode foil may also be subjected to chemical conversion treatment.

The cathode foil may include a conductive coating layer. If the metal foil contains a valve action metal, the coating layer may contain at least one of carbon and a metal whose ionization tendency is lower than that of the valve action metal. This makes it easier to improve acid resistance of the metal foil. If the metal foil contains aluminum, the coating layer may contain at least one selected from the group consisting of carbon, nickel, titanium, tantalum, and zirconium. From the viewpoint of valuing low cost and low resistance, the coating layer may contain at least one of nickel and titanium.

The thickness of the coating layer may be 5 nm or more, or 10 nm or more. The thickness of the coating layer may be 200 nm or less. The coating layer may be formed using the above metal by performing deposition or sputtering onto the metal foil. Alternatively, the coating layer may be formed using a conductive carbon material by performing deposition onto the metal foil or by applying a carbon paste containing the conductive carbon material to the metal foil. Examples of the conductive carbon material include graphite, hard carbon, soft carbon, and carbon black.

### (Separator)

The separator contains a fiber material. The separator may be a porous sheet containing the fiber material. Due to the separator containing the fiber material, sufficient voids can be formed inside the separator. This makes it possible to cause the second conductive polymer layer to sufficiently permeate the inside of the separator. In this case, a favorable conductive path can be formed between the separator and the first conductive polymer layer formed so as to cover the surface of the dielectric layer of the anode foil. Also, if the first conductive polymer layer is formed so as to cover a surface of the cathode foil, a favorable conductive path can also be formed between the separator and the first conductive polymer layer formed on the surface of the cathode foil. In this case, it is possible to form a favorable conductive path connecting the surface of the dielectric layer of the anode foil to the surface of the cathode foil via the separator. Therefore, the ESR of the electrolytic capacitor can be further reduced.

Examples of the separator include woven fabric and non-woven fabric. The thickness of the separator is not particularly limited and may be within a range from 10 μm to 300 μm. Examples of the material of the separator include cellulose, polyethylene terephthalate, polybutylene terephthalate, polyphenylsulfide, vinylon, nylon, aromatic polyamides, polyimides, polyamide imides, polyetherimides, rayon, and glass.

### (Conductive Polymer Layers)

The first conductive polymer layer contains the first conductive polymer. Examples of the first conductive polymer include polypyrrole, polythiophene, polyfuran, polyaniline, polyacetylene, polyphenylene, polyphenylene vinylene, polyacene, polythiophene vinylene, and derivatives thereof. Any one of these may be used alone or two or more of them may be used in combination. The first conductive polymer may also be a copolymer of two or more monomers.

In this specification, polypyrrole, polythiophene, polyfuran, polyaniline, etc., mean polymers respectively including polypyrrole, polythiophene, polyfuran, polyaniline, etc., as basic skeltons. Accordingly, polypyrrole, polythiophene, polyfuran, polyaniline, etc., also encompass derivatives thereof. For example, polythiophene encompasses poly(3,4-ethylenedioxythiophene) and the like.

The first conductive polymer may further include a dopant. The dopant may be a polymer dopant. The polymer dopant may be a polyanion. Specific examples of the polyanion include polyvinyl sulfonic acid, polystyrene sulfonic acid, polyallyl sulfonic acid, polyacryl sulfonic acid, polymethacryl sulfonic acid, poly(2-acrylamide-2-methylpropane sulfonic acid), polyisoprene sulfonic acid, and polyacrylic acid. Any one of these may be used alone or two or more of them may be used in combination. Each of these may be a polymer of a single monomer or a copolymer of two or more monomers. The polymer dopant preferably has a sulfonic acid group. It is preferable to use a polyanion derived from polystyrene sulfonic acid as the polymer dopant.

The weight average molecular weight Mw of the first conductive polymer is preferably 100 to 3000, more preferably 300 to 2500, and further preferably 500 to 2000. The weight average molecular weight Mw of the first conductive polymer can be measured by gel permeation chromatography (GPC) or electrospray ionization mass spectrometry (ESI-MS).

### (Second Conductive Polymer Layer)

The second conductive polymer layer contains the second conductive polymer. The second conductive polymer is not particularly limited, and may be a conductive polymer similar to the first conductive polymer. Also, the second conductive polymer may include a dopant similar to the dopant of the first conductive polymer. That is, the second conductive polymer may include a polyanion as the dopant.

The polymerization degree of the second conductive polymer is preferably higher than that of the first conductive polymer. In other words, the polymerization degree of the first conductive polymer is preferably lower than that of the second conductive polymer. In this case, the electrical conductivity of the first conductive polymer becomes lower than that of the second conductive polymer, and accordingly, it is easy to adjust the electrical conductivity of the first conductive polymer layer to be lower than that of the second conductive polymer layer.

The weight average molecular weight Mw of the second conductive polymer is preferably 300 to 5000, more preferably 500 to 4000, and further preferably 1000 to 3000. The weight average molecular weight Mw of the second conductive polymer can be measured by gel permeation chromatography (GPC) or electrospray ionization mass spectrometry (ESI-MS).

In the electrolytic capacitor according to the embodiment of the present disclosure, the electrical conductivity of the first conductive polymer layer is lower than that of the second conductive polymer layer as described above. The electrical conductivity of the first conductive polymer layer and the electrical conductivity of the second conductive polymer layer can be measured by a four-probe method in accordance with JIS K 7194:1994.

The electrical conductivity of the first conductive polymer layer is preferably between 100 S/cm and 500 S/cm, more preferably between 150 S/cm and 450 S/cm, and further preferably between 200 S/cm and 400 S/cm. The electrical conductivity of the second conductive polymer layer is preferably between 300 S/cm and 800 S/cm, more preferably between 350 S/cm and 750 S/cm, and further preferably between 400 S/cm and 700 S/cm.

If both the first conductive polymer and the second conductive polymer include a dopant, the doping ratio of the dopant in the first conductive polymer is preferably lower than the doping ratio of the dopant in the second conductive polymer. In this case, it is possible to make the size of the first conductive polymer small, and accordingly, the first conductive polymer layer containing the first conductive polymer can more sufficiently permeate the inside of pores in the porous portion. In this case, the electrical conductivity of the first conductive polymer becomes lower than that of the second conductive polymer, and accordingly, it is easy to adjust the electrical conductivity of the first conductive polymer layer to be lower than that of the second conductive polymer layer. The doping ratio of the first conductive polymer can be calculated using the masses of monomers that constitute the first conductive polymer and the dopant, and the masses of solids (the first conductive polymer and the dopant) after the polymerization reaction. The doping ratio of the second conductive polymer can be calculated similarly to the doping ratio of the first conductive polymer.

When the doping ratio of the second conductive polymer is taken to be 100%, the doping ratio of the first conductive polymer is preferably 50% to 95%, more preferably 55% to 90%, and further preferably 60% to 85%.

It is preferable that the first conductive polymer includes a first polymer dopant that has a sulfonic acid group as the dopant, and the second conductive polymer includes a second polymer dopant that has a sulfonic acid group as the dopant. In this case, the weight average molecular weight Mw1 of the first polymer dopant is preferably smaller than the weight average molecular weight Mw2 of the second polymer dopant. In this case, the electrical conductivity of the first conductive polymer can be made lower than that of the second conductive polymer. Accordingly, it is easy to adjust the electrical conductivity of the first conductive polymer layer to be lower than that of the second conductive polymer layer. The weight average molecular weight Mw1 of the first polymer dopant and the weight average molecular weight Mw2 of the second polymer dopant can be measured by gel permeation chromatography (GPC) or electrospray ionization mass spectrometry (ESI-MS).

If both the first polymer dopant and the second polymer dopant have a sulfonic acid group, it is preferable that the degree of sulfonation of the first polymer dopant is lower than the degree of sulfonation of the second polymer dopant. In this case, the electrical conductivity of the first conductive polymer can be made lower than that of the second conductive polymer. Accordingly, it is easy to adjust the electrical conductivity of the first conductive polymer layer to be lower than that of the second conductive polymer layer. The degrees of sulfonation of the first polymer dopant and the second polymer dopant can be determined using a combination of NMR analysis, Raman spectroscopy, X-ray photoelectron spectroscopy (XPS), and X-ray fluorescence analysis.

It is preferable that both the first conductive polymer layer and the second conductive polymer layer contain an alkaline component. Examples of the alkaline component include ammonia, ethanolamine, triethanolamine, dimethylamine, diethylamine, triethylamine, morpholine, and imidazole. The content of the alkaline component in the first conductive polymer layer is preferably higher than the content of the alkaline component in the second conductive polymer layer. In this case, the electrical conductivity of the first conductive polymer layer can be made lower than that of the second conductive polymer layer. Also, it is easy to make the first conductive polymer layer permeate the inside of pores in the porous portion of the anode foil. Furthermore, it is easy to make the first conductive polymer layer permeate the inside of pores in the porous portion of the cathode foil.

It is preferable that both the first conductive polymer layer and the second conductive polymer layer contain an organic solvent having a boiling point of 150° C. or higher (hereinafter referred to as a “high-boiling point solvent”). In this case, it is preferable that the content of the high-boiling point solvent in the first conductive polymer layer is lower than the content of the high-boiling point solvent in the second conductive polymer layer. Examples of the high-boiling point solvent include ethylene glycol and propylene glycol. The high-boiling point solvent can improve the orientation of a conductive polymer in a conductive polymer dispersion for forming a conductive polymer layer. That is, the higher the content of the high-boiling point solvent in a conductive polymer layer is, the further the orientation of a conductive polymer in the conductive polymer layer is improved. The further the orientation of the conductive polymer is improved, the higher the electrical conductivity of the conductive polymer layer becomes. Accordingly, if the content of the high-boiling point solvent in the first conductive polymer layer is made lower than the content of the high-boiling point solvent in the second conductive polymer layer, it is easy to adjust the electrical conductivity of the first conductive polymer layer to be lower than the electrical conductivity of the second conductive polymer layer.

The first conductive polymer layer preferably contains a water-soluble polymer compound. Examples of the water-soluble polymer compound include polyvinyl alcohol (PVA) and polyvinylpyrrolidone (PVP). If the first conductive polymer layer contains a water-soluble polymer compound, the electrical conductivity of the first conductive polymer layer can be reduced. Also, the withstand voltage can be improved. Furthermore, the adhesion of the first conductive polymer layer to the porous portion of the anode foil and the porous portion of the cathode foil can be improved.

It is preferable that the first conductive polymer layer and the second conductive polymer layer form a conductive path connecting the dielectric layer of the anode foil to the cathode foil via the separator. If the cathode foil includes a porous portion in at least a portion of its surface and a dielectric layer is formed in at least a portion of the surface (the outer surface and the inner surface) of the porous portion as described above, it is preferable that the first conductive polymer layer and the second conductive polymer layer form a conductive path connecting the dielectric layer of the anode foil to the dielectric layer of the cathode foil via the separator.

It is preferable that the first conductive polymer layer and the second conductive polymer layer form a conductive path connecting the dielectric layer of the anode foil to the cathode foil via the separator. Also, the conductive path is preferably formed in such a manner as to continuously connect the surface of the dielectric layer of the anode foil and the surface of the cathode foil. With this configuration, the ESR of the electrolytic capacitor can be further reduced. Also, it is preferable that the first conductive polymer layer and the second conductive polymer layer are in contact with the anode foil, the cathode foil, and the separator in a sufficiently large area. In this case, a more favorable conductive path can be formed in the electrolytic capacitor, and the ESR can be further reduced. If the cathode foil includes a porous portion in at least a portion of its surface and a dielectric layer is formed in at least a portion of the surface (the outer surface and the inner surface) of the porous portion as described above, it is preferable that the first conductive polymer layer and the second conductive polymer layer form a conductive path connecting the dielectric layer of the anode foil to the dielectric layer of the cathode foil via the separator.

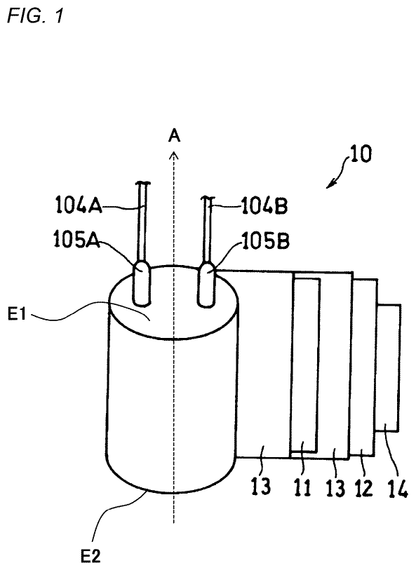

As described above, the capacitor element according to the embodiment of the present disclosure includes the anode foil having an elongated shape, the cathode foil having an elongated shape, and the separator having an elongated shape and disposed between the anode foil and the cathode foil. As shown in FIG. 1, a capacitor element 10 according to the embodiment of the present disclosure includes an anode foil 11, a cathode foil 12, and a separator 13 that are wound in the longitudinal direction of elongated shapes to form a wound body.

As shown in FIG. 1, the wound body includes the anode foil 11 connected to a lead tab (anode lead) 105A, the cathode foil 12 connected to a lead tab (cathode lead) 105B, and the separator 13. The capacitor element 10 includes the first conductive polymer layer and the second conductive polymer layer (not shown). A lead wire 104A is connected to the lead tab (anode lead) 105A, and a lead wire 104B is connected to the lead tab (cathode lead) 105B.

The anode foil 11 and the cathode foil 12 are wound with the separator 13 disposed therebetween to form the wound body. The outermost circumferential surface of this wound body is fixed with a winding end tape 14. FIG. 1 shows a state where a portion of the wound body is expanded before the outermost circumferential surface is fixed with the winding end tape 14.

As shown in FIG. 1, the wound body has a first end surface E1 and a second end surface E2 in a winding axis direction A. The capacitor element 10 includes the lead tab (anode lead) 105A connected to the anode foil 11 and the lead tab (cathode lead) 105B connected to the cathode foil 12 as described above. As shown in FIG. 1, in the capacitor element 10, the lead tab (anode lead) 105A and the lead tab (cathode lead) 105B protrude from the first end surface E1 of the wound body.

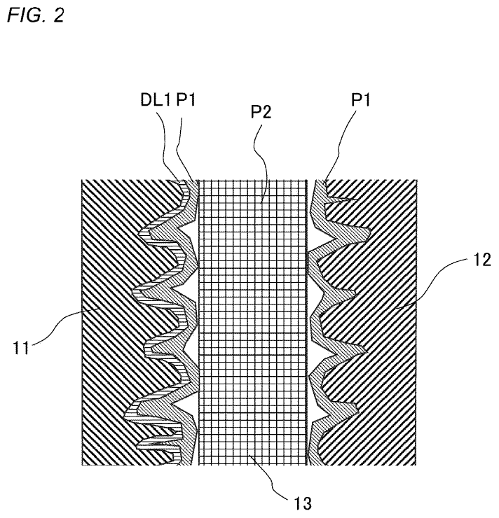

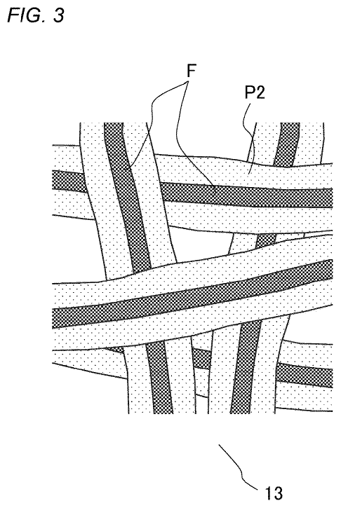

In the capacitor element according to the embodiment of the present disclosure, a first conductive polymer layer P1 and a second conductive polymer layer P2 may be formed as shown in FIGS. 2 and 3, for example.

Specifically, the first conductive polymer layer P1 may be formed so as to cover a surface of a dielectric layer DLI formed on a surface of the anode foil 11 and a surface of the cathode foil 12, and the second conductive polymer layer P2 may be formed so as to cover surfaces of fibers F contained in the separator 13.

Also, from the viewpoint of forming a favorable conductive path from the anode foil 11 to the cathode foil 12 via the separator, at least a portion of the second conductive polymer layer P2 covering the fibers F of the separator 13 may be in contact with at least a portion of the first conductive polymer layer P1 covering the surface of the dielectric layer DLI and at least a portion of the first conductive polymer layer P1 covering the surface of the cathode foil 12.

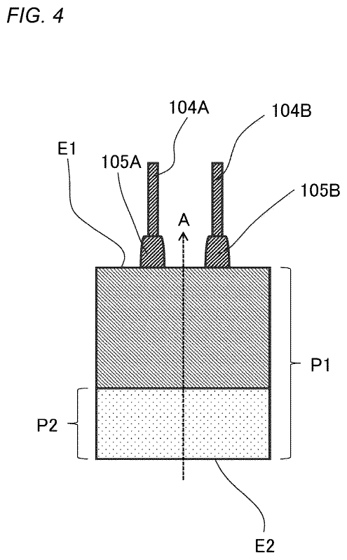

In the capacitor element according to the embodiment of the present disclosure, the second conductive polymer layer may be unevenly formed in at least one of the dielectric layer, the cathode foil, and the separator so as to be located in a portion that is closer to the second end surface than the first end surface of the wound body. For example, out of the two end surfaces in the winding axis direction A, if an end surface from which the lead tab (anode lead) 105A and the lead tab (cathode lead) 105B protrude is the first end surface E1, and the opposite end surface is the second end surface E2, the second conductive polymer layer P2 may be unevenly formed so as to be located in a portion near the second end surface E2 as shown in FIG. 4. That is, the second conductive polymer layer P2 may be unevenly formed so as to be located in a portion spaced apart from the lead tab (anode lead) 105A and the lead tab (cathode lead) 105B. On the other hand, the first conductive polymer layer P1 may be formed across the entire region extending from the first end surface E1 to the second end surface E2. In this case, in the portion near the second end surface E2, the first conductive polymer layer P1 is formed so as to cover the surface of the dielectric layer DLI formed on the surface of the anode foil 11 and the surface of the cathode foil 12 and the second conductive polymer layer P2 is formed so as to cover the surfaces of the fibers F contained in the separator 13 as shown in FIGS. 2 and 3, and in a portion near the first end surface E1, the second conductive polymer layer P2 is not present in the separator 13. Also, a lead wire 104A may be connected to the lead tab (anode lead) 105A and a lead wire 104B may be connected to the lead tab (cathode lead) 105B as shown in FIG. 4.

### (Exterior Body)

The capacitor element may be covered by an exterior body. The exterior body includes at least one of a case and a sealing resin. There is no limitation on the case and the sealing resin, and a known case and a known sealing resin can be used. The sealing resin may include a thermosetting resin. Examples of the thermosetting resin include epoxy resin, phenolic resin, silicone resin, melamine resin, urea resin, alkyd resin, polyurethane resin, polyimide resin, and unsaturated polyester resin. The sealing resin may also contain at least one selected from the group consisting of a filler, a curing agent, a polymerization initiator, and a catalyst.

### <Liquid Component>

The liquid component includes a non-aqueous solvent and an electrolyte solution. It is possible to use a non-aqueous electrolyte solution containing a non-aqueous solvent and a solute dissolved in the non-aqueous solvent as the electrolyte solution. It is possible to use a non-aqueous solvent and a solute used in various known electrolytic capacitors as the non-aqueous solvent and the solute. The liquid component may be a component that is liquid at room temperature (25° C.) or at temperatures at which the electrolytic capacitor is used.

The non-aqueous solvent may be an organic solvent or an ionic liquid.

Examples of the organic solvent include glycol compounds, sulfone compounds, and lactone compounds. Examples of the glycol compounds include ethylene glycol (EG), diethylene glycol (DEG), triethylene glycol (TEG), and propylene glycol (PG). Examples of the sulfone compounds include sulfolane (SL), dimethylsulfoxide (DMSO), and diethylsulfoxide (DESO). Examples of the lactone compounds include γ-butyrolactone (GBL) and γ-valerolactone (GVL).

Examples of the organic solvent also include carbonate compounds, monovalent alcohols, and alcohols whose valency is three or more. Examples of the carbonate compounds include dimethyl carbonate (DMC), diethyl carbonate (DEC), ethyl methyl carbonate (EMC), ethylene carbonate (EC), propylene carbonate (PC), and fluoroethylene carbonate (FEC). Examples of the monovalent alcohols and alcohols whose valency is three or more include glycerin and polyglycerin. Any one of these may be used alone or two or more of them may be used in combination.

Among organic solvents, when a group consisting of glycol compounds, sulfone compounds, and lactone compounds is referred to as a first group and a group consisting of carbonate compounds, monovalent alcohols, and alcohols whose valency is three or more is referred to as a second group, the amount of organic solvents belonging to the first group is preferably more than 50% by mass, more preferably 60% by mass or more, and further preferably 70% by mass or more of the total amount of organic solvents that are contained. All organic solvents that are contained may be organic solvents belonging to the first group. That is, organic solvents belonging to the first group may be used as main solvents, and organic solvents belonging to the second group may be used as auxiliary solvents.

It is preferable that the liquid component includes at least one selected from the group consisting of glycol compounds, sulfone compounds, and lactone compounds as an organic solvent. If the liquid component includes at least one of these compounds, the reformation of the dielectric layer can be carried out efficiently by an acid component contained in the liquid component. In addition, if the liquid component includes a glycol compound, protons (H⁺) included in the glycol compound (specifically, protons (H⁺) included in hydroxy groups) can be easily donated to the conductive polymers constituting the conductive polymer layers. That is, affinity with the conductive polymer layers can be improved. Moreover, sulfone compounds and lactone compounds are aprotonic, and therefore, if the liquid component includes at least one of a sulfone compound and a lactone compound, it is possible to suppress a reaction (e.g., esterification reaction) between the liquid component and an acid component. That is, it is possible to improve the stability of the liquid component even in a high-temperature environment (e.g., in an environment at 145° C.). This makes it possible to stabilize characteristics of the electrolytic capacitor.

If the liquid component includes at least one selected from the group consisting of glycol compounds, sulfone compounds, and lactone compounds as an organic solvent, the proportion of glycol compounds in the liquid component is preferably 40% by mass or more and 80% by mass or less, the proportion of sulfone compounds in the liquid component is preferably 20% by mass or more and 60% by mass or less, and the proportion of lactone compounds in the liquid component is preferably 40% by mass or more and 80% by mass or less. If glycol compounds, sulfone compounds, or lactone compounds are contained in the above ranges, the reformation of the dielectric layer by an acid component contained in the liquid component can be carried out more efficiently.

From the viewpoint of donating protons to the conductive polymers, the liquid component may also include a compound other than glycol compounds. Examples of the other compound include glycerin and polyglycerin.

The liquid component may also include water. The proportion of water content in the liquid component may be 0.1% by mass or more and 6.0% by mass or less, 0.2% by mass or more and 4.0% by mass or less, or 0.5% by mass or more and 2.0% by mass or less. If water is included in the liquid component within the above range, the repairability of the dielectric layer by the liquid component can be enhanced. Also, fluctuations of the ESR value can be suppressed when the electrolytic capacitor is used at high temperatures (e.g., when used at 145° C.). Note that sulfone compounds have excellent hydrolysis resistance, and therefore, hydrolysis resistance of the liquid component can be enhanced if the liquid component includes a sulfone compound as described above.

In the electrolytic capacitor according to the embodiment of the present disclosure, the liquid component includes a cationic component and an anionic component as the solute. Examples of the cationic component include a base component (base), and examples of the anionic component include an acid component (acid). The proportion of the solute in the liquid component is preferably 70% by mass or less, and more preferably 50% by mass or less.

Examples of the base component include ammonia and N-alkylmorpholine. It is preferable to use N-methylmorpholine as N-alkylmorpholine.

The base component may also be a compound that has an alkyl-substituted amidine group, such as imidazole compounds, benzoimidazole compounds, and alicyclic amidine compounds (pyrimidine compounds, imidazoline compounds). More specifically, preferable examples of the base component include: 1,8-diazabicyclo [5,4,0] undecene-7; 1,5-diazabicyclo [4,3,0]nonene-5; 1,2-dimethylimidazolinium; 1,2,4-trimethylimidazoline; 1-methyl-2-ethylimidazoline; 1,4-dimethyl-2-ethylimidazoline; 1-methyl-2-heptylimidazoline; 1-methyl-2-(3′heptyl) imidazoline; 1-methyl-2-dodecylimidazoline; 1,2-dimethyl-1,4,5,6-tetrahydropyrimidine; 1-methylimidazole; and 1-methylbenzoimidazole. By using these, it is possible to obtain an electrolytic capacitor having excellent impedance characteristics.

It is also possible to use a quaternary salt of a compound having an alkyl-substituted amidine group as the base component. Examples of such a base component include imidazole compounds, benzoimidazole compounds, and alicyclic amidine compounds (pyrimidine compounds and imidazoline compounds) quaternized with an alkyl group or arylalkyl group having 1 to 11 carbon atoms. More specifically, preferable examples of the base component include: 1-methyl-1,8-diazabicyclo [5,4,0]undecene-7; 1-methyl-1,5-diazabicyclo [4,3,0]nonene-5; 1,2,3-trimethylimidazolinium; 1,2,3,4-tetramethylimidazolinium; 1,2-dimethyl-3-ethyl-imidazolinium; 1,3,4-trimethyl-2-ethylimidazolinium; 1,3-dimethyl-2-heptylimidazolinium; 1,3-dimethyl-2-(3′heptyl) imidazolinium; 1,3-dimethyl-2-dodecylimidazolinium; 1,2,3-trimethyl-1,4,5,6-tetrahydropyrimidium; 1,3-dimethylimidazolium; 1-methyl-3-ethylimidazolium; and 1,3-dimethylbenzoimidazolium. By using these, it is possible to obtain an electrolytic capacitor having excellent impedance characteristics.

It is also possible to use a tertiary amine as the base component. Examples of the tertiary amine include trialkylamines and amines having a phenyl group. Examples of the trialkylamines include trimethylamine, dimethylethylamine, methyldiethylamine, triethylamine, dimethyl-n-propylamine, dimethylisopropylamine, methylethyl-n-propylamine, methylethylisopropylamine, diethyl-n-propylamine, diethylisopropylamine, tri-n-propylamine, triisopropylamine, tri-n-butylamine, and tri-tert-butylamine. Examples of the amines having a phenyl group include dimethylphenylamine, methylethylphenylamine, and diethylphenylamine. From the viewpoint of increasing electrical conductivity, it is preferable to use trialkylamines, and it is preferable to use at least one trialkylamine selected from the group consisting of trimethylamine, dimethylethylamine, methyldiethylamine, and triethylamine. It is also possible to use a secondary amine such as dialkylamine, a primary amine such as monoalkylamine, and ammonia as the base component.

It is also possible to use a heterocyclic amine as the base component. Examples of the heterocyclic amine include morpholines, and examples of the morpholines include morpholine and morpholine derivatives. Specific examples include morpholine, N-alkylmorpholine, and N-hydroxyalkylmorpholine, and examples of the N-alkylmorpholine include N-methylmorpholine, N-butylmorpholine, and 4-isobutylmorpholine. It is also possible to use pyridine, imidazole, or the like as a heterocyclic amine.

The acid component is, for example, at least one selected from the group consisting of aromatic carboxylic acids, aliphatic carboxylic acids, and salts thereof. The aromatic carboxylic acids and aliphatic carboxylic acids may be polycarboxylic acids or monocarboxylic acids. Examples of aliphatic polycarboxylic acids include saturated polycarboxylic acids and unsaturated polycarboxylic acids. Examples of the saturated polycarboxylic acids include oxalic acid, malonic acid, succinic acid, glutanic acid, adipic acid, pimeric acid, suberic acid, azelaic acid, sebacic acid, 1,6-decanedicarboxylic acid, and 5,6-decanecarboxylic acid, and examples of the unsaturated polycarboxylic acids include maleic acid, fumaric acid, and itaconic acid. Examples of aromatic polycarboxylic acids include phthalic acid, isophthalic acid, terephthalic acid, trimellitic acid, pyromellitic acid, and benzoic acid. Phthalic acid may be o-phthalic acid. Examples of aromatic monocarboxylic acids include salicylic acid.

Examples of polycarboxylic acids also include alicyclic polycarboxylic acids. Examples of the alicyclic polycarboxylic acids include cyclohexane-1,2-dicarboxylic acid and cyclohexene-1,2-dicarboxylic acid.

Examples of monocarboxylic acids include aliphatic monocarboxylic acids and aromatic monocarboxylic acids. In this specification, aromatic monocarboxylic acid is a concept that encompasses oxycarboxylic acid. Examples of the aliphatic monocarboxylic acids include saturated monocarboxylic acids and unsaturated monocarboxylic acids. Examples of the saturated monocarboxylic acids include formic acid, acetic acid, propionic acid, butyric acid, isobutyric acid, valeric acid, caproic acid, enanthic acid, caprylic acid, pelargonic acid, lauric acid, myristic acid, stearic acid, and behenic acid, and examples of the unsaturated monocarboxylic acids include acrylic acid, methacrylic acid, and oleic acid. Examples of the aromatic monocarboxylic acids include benzoic acid, cinnamic acid, and naphthoic acid. Examples of the oxycarboxylic acid include salicylic acid, mandelic acid, and resorcylic acid.

As an aromatic carboxylic acid, it is preferable to use at least one selected from the group consisting of o-phthalic acid, salicylic acid, and benzoic acid. As an aliphatic carboxylic acid, it is preferable to use at least one selected from the group consisting of adipic acid, azelaic acid, and sebacic acid.

It is also possible to use an inorganic acid as the acid component. Examples of the inorganic acid include phosphoric acid, phosphorous acid, hypophosphorous acid, alkyl phosphate, boric acid, borofluoric acid, tetrafluoroboric acid, hexafluorophosphoric acid, benzenesulfonic acid, and naphthalenesulfonic acid. It is also possible to use a composite compound formed by an organic acid and an inorganic acid as the acid component. Examples of the composite compound include dicarboxylic acid derivatives such as borodiglycolic acid, borodioxalic acid, and borodisalicylic acid.

The liquid component may also contain a salt of the acid component and the base component. The salt may be an inorganic salt or an organic salt. Organic salts are salts in which at least one of the anions and cations include an organic substance. Examples of organic salts include trimethylamine maleate, triethylamine borodisalicylate, ethyldimethylamine phthalate, 1,2,3,4-tetramethylimidazolinium monophthalate, and 1,3-dimethyl-2-ethylimidazolinium monophthalate. An amine salt of a long-chain dibasic carboxylic acid may also be used as an organic salt. Examples of the amine salt of a long-chain dibasic carboxylic acid include 2-butyloctanedioic acid diethylamine (2BA).

The term “ionic liquid” means the same as a melted salt (molten salt) and refers to an ionic substance that is liquid at 25° C., for example.

Examples of cations that constitute the ionic liquid include cations of heterocyclic rings containing nitrogen atoms (such as imidazolium, pyrrolidinium, piperidinium, pyridinium, and morpholinium), ammonium, phosphonium, sulfonium, and derivatives thereof (such as substitution products including a substituent such as an alkyl group). The cations may be organic cations.

Examples of anions that constitute the ionic liquid include hydrogen sulfate ions (HSO₄⁻), sulfate ions (SO₄²⁻, −SO₄⁻), carboxylate anions (—COO⁻), nitrate anions, sulfonate anions (—SO₃⁻), and phosphonate anions (PO₃²⁻, −HPO₃⁻). Examples of acids that can produce these anions include sulfuric acid, sulfuric acid monoesters (such as methyl sulfate), carboxylic acids (such as acetic acid, lactic acid, benzoic acid, and trifluoromethane acetate), nitric acid, sulfonic acid (such as methanesulfonic acid, trifluoromethanesulfonic acid, and bis(trifluoromethylsulfonyl)imide anion), phosphonic acid (such as diethylphosphonic acid), and derivatives thereof (such as substitution products including a substituent such as an alkyl group, a halogenated alkyl group, or a halogen atom). Anions may include a fluorine atom. Examples of anions including a fluorine atom include the above-listed trifluoromethane acetate, trifluoromethanesulfonic acid, bis(trifluoromethylsulfonyl)imide anions, and derivatives thereof.

Specific examples of the ionic liquid include 1-butyl-3-methylimidazolium hydrogen sulfate, 1-butyl-3-methylimidazolium bis(trifluoromethanesulfonyl)imide, 1-butyl-3-methylimidazolium trifluoromethanesulfonate, and 1-ethyl-3-methylimidazolium diethyl phosphonate.

The liquid component may also contain a polymer compound. Examples of the polymer compound include polyalkylene glycols, derivatives of polyalkylene glycols, and compounds in which at least one hydroxyl group of polyvalent alcohol is substituted with polyalkylene glycol (including derivatives). Specific examples of the polymer compound include polyethylene glycol (PEG), polyethylene glycol glyceryl ether, polyethylene glycol diglyceryl ether, polyethylene glycol sorbitol ether, polypropylene glycol, polypropylene glycol diglyceryl ether, polypropylene glycol sorbitol ether, and polybutylene glycol.

The polyalkylene glycols may be copolymers (such as random copolymers, block copolymers, or random block copolymers). For example, the polyalkylene glycols may be copolymers of ethylene glycol and propylene glycol, copolymers of ethylene glycol and butylene glycol, or copolymers of propylene glycol and butylene glycol.

The polymer compound may also be a copolymer including an ethylene oxide (EO) unit and a propylene oxide (PO) unit. Examples of such a copolymer include copolymers of EO and PO (EO-PO copolymers) and derivatives thereof. Any one of these may be used alone or two or more of them may be used in combination. The copolymer may be crosslinked by a crosslinking agent. Examples of the derivatives include an EO-PO copolymer in which a hydroxyl group (—OH) that is usually located at the end of the EO-PO copolymer is substituted with an acrylic group (O—CO—CH═CH₂) or the like. When the entire EO-PO copolymer is taken to be 1 mole, the molar ratio between the EO unit and the PO unit is preferably EO:PO=0.9:0.1 to 0.5:0.5. In other words, it is preferable that the EO-PO copolymer includes the EO unit in at least the same amount as the PO unit. In this case, in an electrolytic capacitor including the capacitor element that is housed in a bottomed case whose opening is sealed with a sealing member (e.g., sealing rubber), the EO-PO copolymer contained in the liquid component can be prevented from permeating through the sealing member.

In the electrolytic capacitor according to the embodiment of the present disclosure, the weight average molecular weight Mw of the polymer compound may be 200 or more, 300 or more, 400 or more, or 500 or more. The weight average molecular weight Mw of the polymer compound may be 5000 or less, 4000 or less, 3000 or less, 2000 or less, or 1000 or less.

The weight average molecular weight Mw of the polymer compound can be measured by GPC.

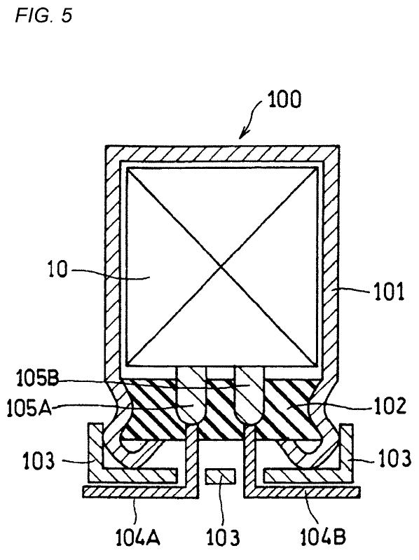

The following describes a specific configuration of an electrolytic capacitor according to an embodiment of the present disclosure with reference to FIG. 5. FIG. 5 is a schematic cross-sectional view of an electrolytic capacitor 100 according to an embodiment of the present disclosure.

The electrolytic capacitor 100 includes a capacitor element 10, a bottomed case 101 housing the capacitor element 10, a sealing member 102 (e.g., sealing rubber) closing an opening of the bottomed case 101, a seat plate 103 disposed outside the bottomed case 101 to cover the sealing member 102 from the open side of the bottomed case 101, a pair of lead wires 104A and 104B that are drawn out from the sealing member 102 and extend through the seat plate 103, and a pair of lead tabs 105A and 105B connecting the pair of lead wires 104A and 104B to electrodes (e.g., an anode foil 11 and a cathode foil 12, which will be described later) of the capacitor element. A portion of the bottomed case 101 near its open end is recessed through drawing, and the open end of the bottomed case 101 is curled so as to be swaged on the sealing member 102. In the example shown in FIG. 5, the lead wire 104A is connected to the electrode of the capacitor element via the lead tab 105A, and the lead wire 104B is connected to the electrode of the capacitor element via the lead tab 105B.

In the electrolytic capacitor 100 according to an embodiment of the present disclosure, the capacitor element is configured as shown in FIGS. 1 to 4.

The sealing member 102 is formed from an elastic member containing a rubber component. Examples of rubber components that can be used include butyl rubber (IIR), nitrile rubber (NBR), ethylene propylene rubber, ethylene propylene diene rubber (EPDM), chloroprene rubber (CR), isoprene rubber (IR), Hypalon (trademark) rubber, silicone rubber, and fluorine rubber. The sealing member 102 may also contain a filler such as carbon black or silica.

It is sufficient that the electrolytic capacitor according to the present disclosure includes at least one capacitor element, and the electrolytic capacitor may also include a plurality of capacitor elements. The number of capacitor elements included in the electrolytic capacitor is determined as appropriate depending on the application.

### [Method for Manufacturing Electrolytic Capacitor]

An example of a method for manufacturing an electrolytic capacitor according to the embodiment of the present disclosure includes: a step (a) of preparing an anode foil with a dielectric layer, a cathode foil, and a separator; a step (b) of applying a first conductive polymer dispersion obtained by dispersing a first conductive polymer and a dopant in a liquid medium to a surface of the dielectric layer and at least one main surface of the cathode foil; a step (c) of forming a first conductive polymer layer on the at least one surface by removing at least a portion of the liquid medium from the first conductive polymer dispersion; a step (d) of applying a second conductive polymer dispersion obtained by dispersing a second conductive polymer and a dopant in a liquid medium to voids of the separator; a step (e) of forming a second conductive polymer layer in the voids of the separator by removing at least a portion of the liquid medium from the second conductive polymer dispersion; a step (f) of forming a capacitor element by disposing the separator between the anode foil and the cathode foil; and a step (g) of filling voids in the capacitor element with a liquid component containing a cationic component and an anionic component. In the method for manufacturing an electrolytic capacitor according to the embodiment of the present disclosure, the steps (a) to (g) are preferably carried out in this order.

<Step (a)>

There is no particular limitation on the step for preparing an anode foil with a dielectric layer, a cathode foil, and a separator. There is no particular limitation on materials of the anode foil, the cathode foil, and the separator. For example, it is possible to use the anode foil, the cathode foil, and the separator described above.

<Step (b)>

In step (b), the first conductive polymer dispersion may be applied to the surface of the dielectric layer, or may be applied to the at least one main surface of the cathode foil. Alternatively, the first conductive polymer dispersion may be applied to the surface of the dielectric layer and the at least one main surface of the cathode foil. If dielectric layers are formed on both main surfaces of the anode foil, the first conductive polymer dispersion may also be applied to surfaces of the dielectric layers formed on both main surfaces of the anode foil. Also, the first conductive polymer dispersion may be applied to both main surfaces of the cathode foil. The first conductive polymer layer is formed on portions to which the first conductive polymer dispersion is applied.

The first conductive polymer dispersion is applied by coating, for example. Various known methods can be used for coating. Examples of coating methods include coating using a coater, coating using a spray, and coating performed by immersing an object to be coated in the first conductive polymer dispersion. Examples of the coating using a coater include gravure coating and die coating. Examples of the liquid medium include water.

<Step (c)>

There is no particular limitation on the method for removing at least a portion of the liquid medium from the first conductive polymer dispersion in step (c). It is preferable to remove the liquid medium at least by heating the liquid medium. The liquid medium may be removed by being heated under a reduced pressure. If the liquid medium is water, it is preferable to remove the liquid medium by heating the liquid medium to 100° C. or higher.

If the electrolytic capacitor is the wound electrolytic capacitor 100 as shown in FIG. 4, it is possible to form the first conductive polymer layer by impregnating the capacitor element 10 configured as a wound body like that shown in FIG. 1 with the first conductive polymer dispersion, and then heating the capacitor element 10 at a predetermined temperature, for example.

<Step (d)>

In step (d), the second conductive polymer dispersion is applied to the inside of voids of the separator. The second conductive polymer dispersion can be applied to the inside of the voids of the separator using a method similar to the method for applying the first conductive polymer dispersion.

<Step (e)>

In step (e), at least a portion of the liquid medium is removed from the second conductive polymer dispersion similarly to step (c). Thus, the second conductive polymer layer can be formed in the voids of the separator.

<Step (f)>

In step (f), the separator is disposed between the anode foil and the cathode foil after the first conductive polymer layer is formed on the surface of the dielectric layer and the at least one main surface of the cathode foil and the second conductive polymer layer is formed in the voids of the separator, and thus a capacitor element (specifically, a capacitor element including the conductive polymer layers) is formed. This step is a step in which the anode foil and the cathode foil are stacked with the separator therebetween.

In the method for manufacturing an electrolytic capacitor according to the present disclosure, it is preferable that the capacitor element is manufactured as a wound body like that shown in FIG. 1. In the wound body like that shown in FIG. 1, the anode foil, the cathode foil, and the separator are stacked in a radial direction of the wound body.

<Step (g)>

There is no particular limitation on the method for filling voids in the capacitor element with the liquid component. For example, it is possible to fill the voids in the capacitor element with the liquid component by impregnating at least a portion of the capacitor element with the liquid component containing a cationic component and an anionic component. The cationic component and the anionic component described above can be used.

By performing steps (a) to (g) as described above, a capacitor element including the first conductive polymer layer, the second conductive polymer layer, and the liquid component containing a cationic component and an anionic component is formed. Thereafter, the capacitor element is enclosed in an exterior body (case) as necessary. Thus, an electrolytic capacitor according to the embodiment of the present disclosure is manufactured.

In the example described above, the first conductive polymer layer is formed on the surface of the dielectric layer and the at least one main surface of the cathode foil and the second conductive polymer layer is formed in the separator before the anode foil and the cathode foil are stacked with the separator therebetween, but the method for forming the first conductive polymer layer and the second conductive polymer layer is not limited to this example. The first conductive polymer layer and the second conductive polymer layer may be formed after the anode foil and the cathode foil are stacked with the separator therebetween. For example, it is also possible to use a method in which, after a wound body is obtained by stacking the anode foil and the cathode foil with the separator therebetween, the second end surface E2-side (see FIG. 4) of the wound body is immersed in the first conductive polymer dispersion to form the first conductive polymer layer, and the second end surface E2-side (see FIG. 4) of the wound body is immersed in the second conductive polymer dispersion to form the second conductive polymer layer. In this case, if the size of the first conductive polymer is smaller than the size of the second conductive polymer, the first conductive polymer dispersion permeates closer to the first end surface E1 (see FIG. 4) than the second conductive polymer dispersion does, and accordingly, the second conductive polymer layer is formed unevenly so as to be located closer to the second end surface E2 than the first conductive polymer layer is.

### (Supplementary Notes)

The following technologies are disclosed by the above description.

### (Technology 1)

An electrolytic capacitor including a capacitor element and a liquid component,
wherein the capacitor element includes an anode foil having an elongated shape, a cathode foil having an elongated shape, a separator having an elongated shape and disposed between
the anode foil and the cathode foil, and a first conductive polymer layer and a second conductive polymer layer between the anode foil and the cathode foil,
the anode foil, the cathode foil, and the separator are wound in a longitudinal direction of the elongated shapes to form a wound body,
the anode foil includes a porous portion in which at least a portion of a surface is covered with a dielectric layer,
the cathode foil is arranged opposite the dielectric layer,
the separator contains a fiber material,
the first conductive polymer layer covers at least a portion of a surface of the dielectric layer in the porous portion,
the second conductive polymer layer covers at least a portion of a surface of the fiber material in the separator,
the first conductive polymer layer contains a first conductive polymer,
the second conductive polymer layer contains a second conductive polymer, and
a content of the first conductive polymer in the porous portion is higher than a content of the second conductive polymer in the porous portion,
a content of the second conductive polymer in the separator is higher than a content of the first conductive polymer in the separator, and
electrical conductivity of the first conductive polymer layer is lower than electrical conductivity of the second conductive polymer layer.

### (Technology 2)

The electrolytic capacitor according to technology 1,
wherein the first conductive polymer layer further covers at least a portion of a surface of the cathode foil, and
the first conductive polymer layer and the second conductive polymer layer form a conductive path connecting the dielectric layer to the cathode foil via the separator.

### (Technology 3)

The electrolytic capacitor according to technology 1,
wherein the wound body has a first end surface and a second end surface in a winding axis direction, and
the second conductive polymer layer is unevenly formed in the separator so as to be located in a portion closer to the second end surface than the first end surface of the wound body.

### (Technology 4)

The electrolytic capacitor according to technology 3,
wherein the capacitor element includes an anode lead connected to the anode foil and a cathode lead connected to the cathode foil, and
the anode lead and the cathode lead protrude from the first end surface of the wound body.

### (Technology 5)

The electrolytic capacitor according to any one of technologies 1 to 4,
wherein a polymerization degree of the first conductive polymer is lower than a polymerization degree of the second conductive polymer.

### (Technology 6)

The electrolytic capacitor according to any one of technologies 1 to 5,
wherein both the first conductive polymer and the second conductive polymer include a dopant, and
a doping ratio of the dopant in the first conductive polymer is lower than a doping ratio of the dopant in the second conductive polymer.

### (Technology 7)

The electrolytic capacitor according to any one of technologies 1 to 6,
wherein the first conductive polymer includes a first polymer dopant having a sulfonic acid group,
the second conductive polymer includes a second polymer dopant having a sulfonic acid group, and
a weight average molecular weight Mw1 of the first polymer dopant is smaller than a weight average molecular weight Mw2 of the second polymer dopant.

### (Technology 8)

The electrolytic capacitor according to technology 7,
wherein a degree of sulfonation of the first polymer dopant is lower than a degree of sulfonation of the second polymer dopant.

### (Technology 9)

The electrolytic capacitor according to any one of technologies 1 to 8,
wherein both the first conductive polymer layer and the second conductive polymer layer contain an alkaline component, and
a content of the alkaline component in the first conductive polymer layer is higher than a content of the alkaline component in the second conductive polymer layer.

### (Technology 10)

The electrolytic capacitor according to any one of technologies 1 to 9,
wherein both the first conductive polymer layer and the second conductive polymer layer contain an organic solvent with a boiling point of 150° C. or higher, and
a content of the organic solvent in the first conductive polymer layer is lower than a content of the organic solvent in the second conductive polymer layer.

### (Technology 11)

The electrolytic capacitor according to any one of technologies 1 to 10,
wherein the first conductive polymer layer further contains a water-soluble polymer compound.

Although the present invention has been described in terms of the presently preferred embodiment, it is to be understood that such a disclosure is not to be interpreted as limiting. Various alterations and modifications will no doubt become apparent to those skilled in the art to which the present invention pertains, after having read the above disclosure. Therefore, the accompanying claims should be interpreted as encompassing all alterations and modifications without deviating from the true spirit and scope of the present invention.

### EXAMPLES

The following specifically describes the present disclosure using an example and comparative examples, but the present disclosure is not limited to the following example.

### Example 1

Electrolytic capacitors with a rated voltage of 35 V were manufactured as follows.

### (a) Preparation of Components

(a-1) Anode Foil

An aluminum foil with a thickness of 100 μm was etched to roughen surfaces of the aluminum foil. The roughened surfaces of the aluminum foil were subjected to chemical conversion treatment to form dielectric layers, and thus an anode foil was obtained.

(a-2) Cathode Foil

An aluminum foil with a thickness of 50 μm was etched to roughen surfaces of the aluminum foil, and thus a cathode foil was obtained.

### (A-3) Separator

Non-woven fabric (with a thickness of 50 μm) was prepared as a separator. The nonwoven fabric was constituted of 50% by mass of synthetic fibers (25% by mass of polyester fiber and 25% by mass of aramid fiber) and 50% by mass of cellulose, and contained polyacrylamide as a paper strength enhancing agent. The density of the nonwoven fabric was 0.35 g/cm³.

### (B) Preparation of Conductive Polymer Dispersions

### (B-1) Preparation of First Conductive Polymer Dispersion

3,4-ethylenedioxythiophene to which an alkyl group was introduced as a substituent (3,4-ethylenedioxythiophene derivative) and poly(4-styrenesulfonic acid) (PSS, weight average molecular weight Mw 100000, dopant) were dissolved in ion exchanged water to prepare a mixture solution. Then, while the mixture solution was stirred, oxidizing agents (iron (III) sulfate and ammonium persulfate) dissolved in ion exchanged water were added to the mixture solution to cause a polymerization reaction to occur. After the polymerization reaction, the obtained reaction solution was filtered (dialysis) to remove unreacted monomers and excess oxidizing agents. Ammonia, which is an alkaline component, ethylene glycol, and polyacrylic acid were added to the filtered reaction solution, and thus a dispersion liquid in which 2% by mass of the PSS-doped poly(3,4-ethylenedioxythiophene) derivative was dispersed was obtained as a first conductive polymer dispersion. The first conductive polymer dispersion was prepared such that ethylene glycol was contained in an amount of 5% by mass and polyacrylic acid was contained in an amount of 0.5% by mass. Also, the first conductive polymer dispersion was prepared such that the alkaline component was contained in an amount of 0.9 equivalents with respect to 1 equivalent of the PSS-doped poly(3,4-ethylenedioxythiophene). Note that ethylene glycol is an organic solvent with a boiling point of 150° C. or higher, and polyacrylic acid is a water-soluble polymer compound.

### (B-2) Preparation of Second Conductive Polymer Dispersion

3,4-ethylenedioxythiophene and poly(4-styrenesulfonic acid) (PSS, weight average molecular weight Mw 100000, dopant) were dissolved in ion exchanged water to prepare a mixture solution. Then, while the mixture solution was stirred, oxidizing agents (iron (III) sulfate and ammonium persulfate) dissolved in ion exchanged water were added to the mixture solution to cause a polymerization reaction to occur. After the polymerization reaction, the obtained reaction solution was filtered (dialysis) to remove unreacted monomers and excess oxidizing agents. Ethylene glycol was added to the filtered reaction solution, and thus a dispersion liquid in which 2% by mass of the PSS-doped poly(3,4-ethylenedioxythiophene) (PEDOT/PSS) was dispersed was obtained as a second conductive polymer dispersion. The second conductive polymer dispersion was prepared such that ethylene glycol was contained in an amount of 10% by mass.

### (C) Formation of Conductive Polymer Layers

### (C-1) Formation of First Conductive Polymer Layer

The first conductive polymer dispersion was applied so as to cover the dielectric layers on both surfaces of the anode foil with use of a gravure coater. Next, first conductive polymer layers were formed by performing drying so as to cover the dielectric layers on both surfaces of the anode foil. First conductive polymer layers were also formed on both surfaces of the cathode foil in the same manner.

### (C-2) Formation of Second Conductive Polymer Layer

The separator was immersed in the second conductive polymer dispersion contained in a predetermined container for 5 minutes in a reduced-pressure atmosphere (40 kPa). Next, the separator impregnated with the second conductive polymer dispersion was dried in a drying furnace at 150° C. for 20 minutes to form a second conductive polymer layer so as to cover at least a portion of surfaces of the fiber materials of the separator.

### (D) Preparation of Wound Body

Each of the anode foil, the cathode foil, and the separator was cut to have predetermined planar dimensions. An anode lead tab was connected to the anode foil and a cathode lead tab was connected to the cathode foil. The anode foil and the cathode foil were then wound with the separator therebetween to obtain a wound body. At that time, an end of the outer surface of the wound body was fixed with a winding end tape. An anode lead wire was connected to an end of the anode lead tab and a cathode lead wire was connected to an end of the cathode lead tab.

(E) Impregnation with Liquid Component

An electrolyte solution (liquid component) containing polyethylene glycol (PEG), sulfolane (SL), and 2-butyloctanedioic acid diethylamine (2BA) at a ratio of PEG:SL:2BA=45:40:15 was prepared, and the capacitor element was immersed in the electrolyte solution in a reduced-pressure atmosphere (40 kPa) for 5 minutes. Thus, the capacitor element was impregnated with the electrolyte solution.

An electrolytic capacitor like that shown in FIG. 5 was manufactured by sealing the capacitor element according to Example 1. After that, the electrolytic capacitor was aged at 95° C. for 90 minutes while a voltage was applied to the electrolytic capacitor. Thus, an electrolytic capacitor according to Example 1 was obtained. Note that an elastic member containing butyl rubber as a rubber component was used as a sealing member to seal the capacitor element. 60 electrolytic capacitors were manufactured. The same applies to the following examples.

### Comparative Example 1

Electrolytic capacitors according to Comparative Example 1 were manufactured in the same manner as in Example 1, except that the second conductive polymer layer was formed on the anode foil and the cathode foil.

### Comparative Example 2

Electrolytic capacitors according to Comparative Example 2 were manufactured in the same manner as in Example 1, except that the first conductive polymer layer was formed so as to cover at least a portion of the fiber materials of the separator.

### Comparative Example 3

Electrolytic capacitors according to Comparative Example 3 were manufactured in the same manner as in Example 1, except that the second conductive polymer layer was formed on the anode foil and the cathode foil, and the first conductive polymer layer was formed so as to cover at least a portion of the fiber materials of the separator.

### <Evaluation>

### <<Measurement of Capacitance, ESR, and Leakage Current>>

With respect to the electrolytic capacitors of each example (Example 1 and Comparative Examples 1 to 3), the capacitance (unit: μF) was measured at a frequency of 120 Hz and the ESR (unit: mΩ) was measured at a frequency of 100 kHz with use of an LCR meter. The measurement was carried out at a temperature of 20° C. The capacitance and the initial ESR were each measured with respect to 20 electrolytic capacitors to obtain measured values, and arithmetic averages of the measured values were obtained. The arithmetic averages were taken to be the capacitance and the ESR of the electrolytic capacitors of that example. Also, a resistor with a resistance of 1 kΩ was connected in series to an electrolytic capacitor of each example, and a leakage current (unit: μA) was measured after the rated voltage of 35 V was applied for 120 seconds with use of a DC power supply. An arithmetic average of measured values of the leakage current of 20 electrolytic capacitors was taken to be the leakage current value of the electrolytic capacitors of that example. The capacitance, the ESR, and the leakage current (LC) of the electrolytic capacitors of each example are shown in Table 1 below.

TABLE 1

| | S1 | S2 | Capacitance | ESR | LC |
|---|---|---|---|---|---|
| | (S/cm) | (S/cm) | (μF) | (mΩ) | (μA) |
| Example 1 | 285 | 581 | 271 | 10.7 | 3.0 |
| Comparative | — | 581 | 256 | 10.8 | 6.6 |
| Example 1 | | | | | |
| Comparative | 285 | — | 270 | 13.7 | 3.1 |
| Example 2 | | | | | |
| Comparative | 581 | 285 | 257 | 14.1 | 6.2 |
| Example 3 | | | | | |

Table 1 shows that the electrolytic capacitors according to Example 1 had an ESR as low as 10.7 mΩ and a leakage current (LC) value as small as 3.0 μA. On the other hand, the electrolytic capacitors according to Comparative Example 1 had an ESR of 10.8 mΩ, which is low, but the leakage current (LC) value was as large as 6.6 μA. The electrolytic capacitors according to Comparative Example 2 had a leakage current (LC) value of 3.1 μA, which is small, but the ESR was as high as 13.7 mΩ. The electrolytic capacitors according to Comparative Example 3 had an ESR as high as 14.1 mΩ and a leakage current (LC) value as large as 6.2 μA. Note that the electrolytic capacitors according to Example 1 had the highest capacitance (271 μF).

The electrolytic capacitor according to the present disclosure can be used in applications where both suppression of an increase of a leakage current and suppression of an increase in the ESR are required.

### REFERENCE NUMERALS

10: capacitor element, 11: anode foil, 12: cathode foil, 13: separator, 14: winding end tape, 100: electrolytic capacitor, 101: bottomed case, 102: sealing member, 103: seat plate, 104A, 104B: lead wire, 105A, 105B: lead tab

What is claimed is:

1. An electrolytic capacitor comprising a capacitor element and a liquid component,
wherein the capacitor element includes an anode foil having an elongated shape, a cathode foil having an elongated shape, a separator having an elongated shape and disposed between the anode foil and the cathode foil, and a first conductive polymer layer and a second conductive polymer layer between the anode foil and the cathode foil,
the anode foil, the cathode foil, and the separator are wound in a longitudinal direction of the elongated shapes to form a wound body,
the anode foil includes a porous portion in which at least a portion of a surface is covered with a dielectric layer,
the cathode foil is arranged opposite the dielectric layer,
the separator contains a fiber material,
the first conductive polymer layer covers at least a portion of a surface of the dielectric layer in the porous portion,
the second conductive polymer layer covers at least a portion of a surface of the fiber material in the separator,
the first conductive polymer layer contains a first conductive polymer,
the second conductive polymer layer contains a second conductive polymer, and
a content of the first conductive polymer in the porous portion is higher than a content of the second conductive polymer in the porous portion,
a content of the second conductive polymer in the separator is higher than a content of the first conductive polymer in the separator, and
electrical conductivity of the first conductive polymer layer is lower than electrical conductivity of the second conductive polymer layer.

2. The electrolytic capacitor according to claim 1,
wherein the first conductive polymer layer further covers at least a portion of a surface of the cathode foil, and
the first conductive polymer layer and the second conductive polymer layer form a conductive path connecting the dielectric layer to the cathode foil via the separator.

3. The electrolytic capacitor according to claim 1,
wherein the wound body has a first end surface and a second end surface in a winding axis direction, and
the second conductive polymer layer is unevenly formed in the separator so as to be located in a portion closer to the second end surface than the first end surface of the wound body.

4. The electrolytic capacitor according to claim 3,
wherein the capacitor element includes an anode lead connected to the anode foil and a cathode lead connected to the cathode foil, and
the anode lead and the cathode lead protrude from the first end surface of the wound body.

5. The electrolytic capacitor according to claim 1,
wherein a polymerization degree of the first conductive polymer is lower than a polymerization degree of the second conductive polymer.

6. The electrolytic capacitor according to claim 1,
wherein both the first conductive polymer and the second conductive polymer include a dopant, and
a doping ratio of the dopant in the first conductive polymer is lower than a doping ratio of the dopant in the second conductive polymer.

7. The electrolytic capacitor according to claim 1,
wherein the first conductive polymer includes a first polymer dopant having a sulfonic acid group,
the second conductive polymer includes a second polymer dopant having a sulfonic acid group, and
a weight average molecular weight Mw1 of the first polymer dopant is smaller than a weight average molecular weight Mw2 of the second polymer dopant.

8. The electrolytic capacitor according to claim 7,
wherein a degree of sulfonation of the first polymer dopant is lower than a degree of sulfonation of the second polymer dopant.

9. The electrolytic capacitor according to claim 1,
wherein both the first conductive polymer layer and the second conductive polymer layer contain an alkaline component, and
a content of the alkaline component in the first conductive polymer layer is higher than a content of the alkaline component in the second conductive polymer layer.

10. The electrolytic capacitor according to claim 1,
wherein both the first conductive polymer layer and the second conductive polymer layer contain an organic solvent with a boiling point of 150° C. or higher, and
a content of the organic solvent in the first conductive polymer layer is lower than a content of the organic solvent in the second conductive polymer layer.

11. The electrolytic capacitor according to claim 1,
wherein the first conductive polymer layer further contains a water-soluble polymer compound.
